(19) United States
(12) Patent Application Publication
(10) Pub. No.: US 2016/0177835 A1
(43) Pub. Date: Jun. 23, 2016

(54) GAS TURBINE ENGINE WITH ANGULARLY OFFSET TURBINE VANES

(71) Applicant: PRATT & WHITNEY CANADA CORP., Longueuil (CA)

(72) Inventors: Marc Tardif, Candiac (CA); Jacinthe Rondeau, Ste-Julie (CA); Domenico Di Florio, St. Lazare (CA)

(21) Appl. No.: 14/578,888

(22) Filed: Dec. 22, 2014

(51) Int. Cl. F02C 7/22; F23R 3/28

(52) U.S. Cl. CPC F02C 7/222; F23R 3/286; F05D 2220/32; F05D 2240/24

(57) ABSTRACT

A gas turbine engine includes a combustor having a plurality of fuel nozzles arranged circumferentially equidistant from one another about a first center. The plurality of fuel nozzles produce a plurality of pressure pulses in a fluid contained in the combustor. A turbine section is disposed downstream of the combustor and receiving the fluid from the combustor. The turbine section includes a plurality of vanes arranged circumferentially equidistant from one another about a second center. When projecting the second center onto the first center, the plurality of vanes is angularly offset in a circumferential direction relative to the plurality of fuel nozzles of a predetermined amount. The offsetting positions the vanes in flowpaths of the pressure pulses generated by the plurality of fuel nozzles.

### TECHNICAL FIELD

The application relates generally to gas turbine engines and, more particularly, to arrangements between fuel nozzles and vanes downstream thereof.

### BACKGROUND

Gas turbine engines generally include a compressor section to pressurize an airflow, a combustor for burning a hydrocarbon fuel in the presence of the pressurized air, and a turbine section for extracting energy from the resultant combustion gases. A plurality of circumferentially distributed fuel nozzles project into the combustor to supply the fuel to be mixed with the pressurized air. The fuel nozzles produce a plurality of alternating hot and cold pulses (a.k.a. streaks) in the fluid contained in the combustor. The hot and cold pulses are moved downstream through the turbine section. The pressure pulses associated to the hot and cold pulses may cause vibratory stresses in the rotating parts of the turbine section.

### SUMMARY

In one aspect, there is provided a gas turbine engine comprising: a combustor including: a plurality of fuel nozzles arranged circumferentially equidistant from one another about a first center, the plurality of fuel nozzles producing a plurality of pressure pulses in a fluid contained in the combustor; and a turbine section disposed downstream of the combustor and receiving the fluid from the combustor, the turbine section including: a plurality of vanes arranged circumferentially equidistant from one another about a second center; and wherein when projecting the second center onto the first center, the plurality of vanes being angularly offset in a circumferential direction relative to the plurality of fuel nozzles of a predetermined amount, the offsetting positioning the vanes in flowpaths of the pressure pulses generated by the plurality of fuel nozzles.

In another aspect, there is provided a gas turbine engine comprising: a combustor including: a plurality of fuel nozzles arranged circumferentially equidistant from one another about a first center, the plurality of fuel nozzles producing a plurality of pulses in a fluid contained in the combustor; and a turbine section disposed downstream of the combustor and receiving the fluid from the combustor, the turbine section including: a plurality of vanes arranged circumferentially equidistant from one another about a second center; and wherein when projecting the second center onto the first center, the plurality of vanes being angularly offset in a circumferential direction relative to the plurality of fuel nozzles of a predetermined amount, the offsetting positioning the vanes in flowpaths of the pressure pulses generated by the plurality of fuel nozzles, a clocking angle being defined between any of the vanes and a circumferentially consecutive fuel nozzle of the vane, the clocking angle is comprised between −18 and +18 degrees.

In a further aspect, there is provided a method of reducing vibratory stresses in a turbine disposed downstream of a plurality of fuel nozzles of a gas turbine engine, the turbine including a rotor disposed immediately downstream from a stator, the method comprising: positioning the vanes of the stator angularly offset in a circumferential direction relative to the fuel nozzles, the fuel nozzles forming pressure pulses of fluid and the angular offsetting disposing the vanes in flowpaths of the pressure pulses, the fuel nozzles being arranged circumferentially equidistant from one another about a first center, the vanes being arranged circumferentially equidistant from one another about a second center, the angular offsetting being assessed when projecting the second center onto the first center.

### BRIEF DESCRIPTION OF THE DRAWINGS

Reference is now made to the accompanying figures in which:

FIG. 1 is a schematic cross-section of a gas turbine engine according to a first embodiment;

FIG. 2 is a partial sectional view of an exemplary annular combustor that may be used with the gas turbine engine shown in FIG. 1;

FIG. 3 is a sectional view generally along line A-A in FIG. 2 showing a Nozzle Guide Vane (NGV) superimposed with a fuel nozzle ring according to a first embodiment;

FIG. 4 is a sectional view generally along line A-A in FIG. 2 showing a Nozzle Guide Vane (NGV) (with vane ring and inner cover) superimposed with a fuel nozzle ring according to a second embodiment;

FIG. 5 is a sectional view generally along line A-A in FIG. 2 showing the NGV (with vane ring and inner cover) superimposed with a fuel nozzle ring according to a third embodiment;

FIG. 6A is a schematic front view of a stator including the Nozzle Guide Vane (NGV) and an embodiment of the vane ring;

FIG. 6B is a schematic front view of an embodiment of the inner cover connecting the stator of FIG. 6A to the engine casing; and

FIG. 7 is a schematic cross-section of a gas turbine engine according to a second embodiment.

### DETAILED DESCRIPTION

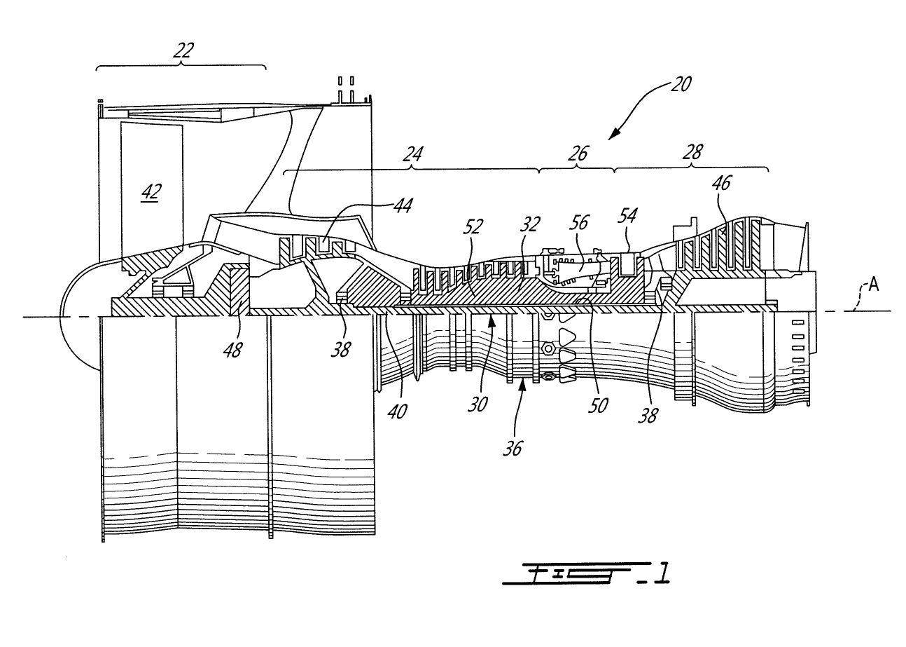

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. Alternative engines might include an augmentor section (not shown) among other systems or features. The fan section 22 drives air along a bypass flowpath while the compressor section 24 drives air along a core flowpath for compression and communication into the combustor section 26 then expansion through the turbine section 28. Although depicted as a turbofan gas turbine engine in the disclosed non-limiting embodiment, it should be understood that the concepts described herein are not limited to use with turbofans as the teachings may be applied to other types of turbine engines such as a three-spool (plus fan) engine wherein an intermediate spool includes an intermediate pressure compressor (IPC) between the LPC and HPC and an intermediate pressure turbine (IPT) between the HPT and LPT, and industrial turbine engine applications.

The engine 20 generally includes a low spool 30 and a high spool 32 mounted for rotation about an engine central longitudinal axis A relative to an engine static structure 36 via several bearing structures 38. The low spool 30 generally includes an inner shaft 40 that interconnects a fan 42, a low pressure compressor 44 (“LPC”) and a low pressure turbine 46 (“LPT”). The inner shaft 40 drives the fan 42 directly or through a geared architecture 48 to drive the fan 42 at a lower speed than the low spool 30. An exemplary reduction transmission is an epicyclic transmission, namely a planetary or star gear system.

The high spool 32 includes an outer shaft 50 that interconnects a high pressure compressor 52 (“HPC”) and high pressure turbine 54 (“HPT”). A combustor 56 is arranged between the high pressure compressor 52 and the high pressure turbine 54. The inner shaft 40 and the outer shaft 50 are concentric and rotate about the engine central longitudinal axis A that is collinear with their longitudinal axes.

Core airflow is compressed by the low pressure compressor 44 then the high pressure compressor 52, mixed with the fuel and burned in the combustor 56, then expanded over the high pressure turbine 54 and low pressure turbine 46. The turbines 54, 46 rotationally drive the respective low spool 30 and high spool 32 in response to the expansion.

The main engine shafts 40, 50 are supported at a plurality of points by bearing structures 38 within the static structure 36. It should be understood that various bearing structures 38 at various locations may alternatively or additionally be provided.

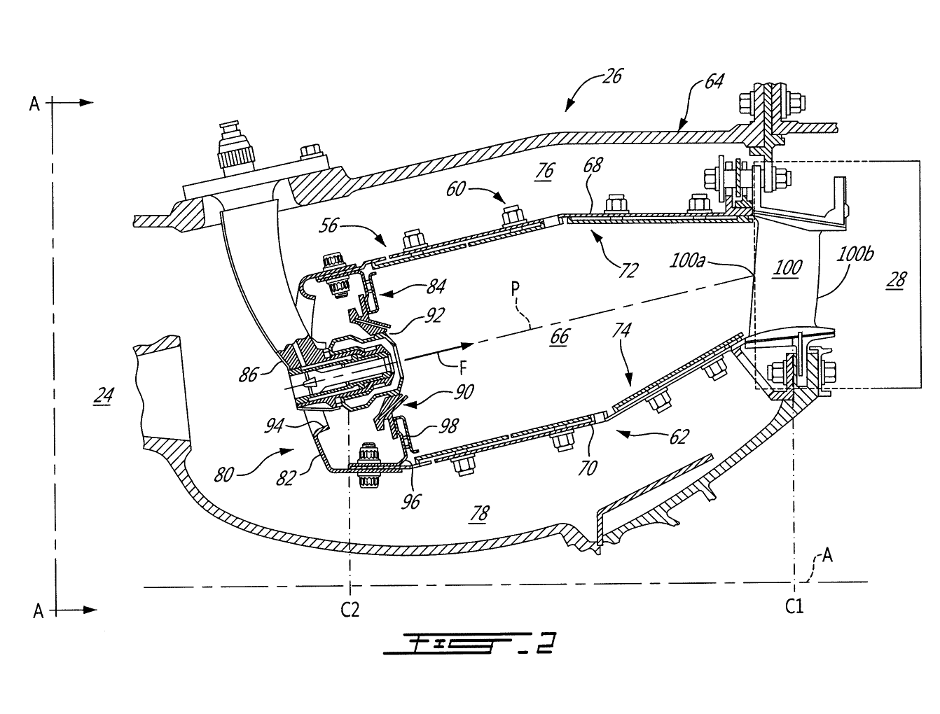

With reference to FIG. 2, the combustor 56 generally includes a combustor outer liner 60 and a combustor inner liner 62. The outer liner 60 and the inner liner 62 are spaced inward from a case 64 such that an annular combustion chamber 66 is defined there between. It should be understood that although a particular combustor is illustrated, other combustor types with various liner panel arrangements will also benefit herefrom.

The outer liner 60 and the case 64 define an annular outer plenum 76 and the inner liner 62 and the case 64 define an annular inner plenum 78. The outer and inner liners 60, 62 contain the flame for direction toward the turbine section 28. Each liner 60, 62 generally includes a respective support shell 68, 70 that supports one or more respective liner panels 72, 74 mounted to a hot side of the respective support shell 68, 70. The liner panels 72, 74 define a liner panel array that may be generally annular in shape. Each of the liner panels 72, 74 may be generally rectilinear and manufactured of, for example, a nickel based super alloy or ceramic material.

The combustor 56 further includes a forward assembly 80 immediately downstream of the compressor section 24 to receive compressed airflow therefrom. The forward assembly 80 generally includes an annular hood 82, a bulkhead assembly 84, a multiple of fuel nozzles 86 (one shown) and a multiple of fuel nozzle guides 90 (one shown) that defines a central opening 92. The annular hood 82 extends radially between, and is secured to, the forwardmost ends of the liners 60, 62. The annular hood 82 includes a multiple of circumferentially distributed hood ports 94 that accommodate the respective fuel nozzle 86 and introduce air into the forward end of the combustion chamber 66. Each fuel nozzle 86 may be secured to the outer case 64 and projects through one of the hood ports 94 and through the central opening 92 within the respective fuel nozzle guide 90 along a fuel nozzle axis F.

A multiple of Nozzle Guide Vanes (NGVs) 100 of the high pressure turbine 54 are located immediately downstream of the combustor 56. The NGVs 100 are static engine components which direct core airflow from the upstream combustor 56. The NGVs 100 direct core airflow combustion gases onto the turbine blades to facilitate the conversion of pressure energy into kinetic energy. The core airflow combustion gases from the combustor 56 are also accelerated by the NGVs 100 because of their convergent shape and are typically given a “spin” or a “swirl” in the direction of turbine rotor rotation. The turbine rotor blades absorb this energy to facilitate rotation of the turbine rotor at high speed. The NGVs 100 in one disclosed non-limiting embodiment are the first static vane structure in the turbine section 28 of the gas turbine engine 20 upstream of a first turbine rotor. The NGVs 100 are airfoil shaped and have a leading edge 100a and a trailing edge 100b. The leading edge 100a is facing the incoming flow F from the combustor 56. A desire for increased aerodynamic and thermodynamic efficiency drives turbine blade designs that may have a high vibratory response to multiple engine order crossings. This vibratory response creates stresses on the rotating turbine blade. An amplitude of the turbine blade vibration may be a function, among others, of a strength of aerodynamic pulses in the incoming flow. The pulses are localized areas of the flow with high pressure. These pulses, which are sometimes called streaks, originate from the fuel nozzles 86. The pulses are defined, among other factors, by the mechanical configuration of the combustor 56, as well as the type and position of the fuel nozzles 86 as they impact on flow swirl and mixing within the combustor 56.

It has been found that arranging the NGVs 100 in a particular manner relative to the aerodynamic pulse pattern exiting the combustor 56 may have an effect on the strength of these pulses downstream of the NGVs 100. The pulse pattern being related to the fuel nozzle 86 arrangement, the angular positioning of the NGVs 100 relative to fuel nozzles 86 may be related to the position of the NGVs 100 relative to the pulses. By disposing the NGVs 100 in the flowpaths (partially or totally) of the pressure pulses (one flowpath P being schematically illustrated as dotted line in FIG. 2), the NGV 100 may be able to break the pulses, and the vibratory stresses on the rotating turbine blade may thus be reduced. In the particular arrangement described herein, the NGVs 100 are “clocked” relative to the fuel nozzles 86. “Clocking”, as used herein, refers to an angularly offsetting of the NGVs 100 relative to fuel nozzles 86 in the circumferential direction C (i.e. at least some if not all of the NGVs 100 do not belong to a same radius as the fuel nozzles 86).

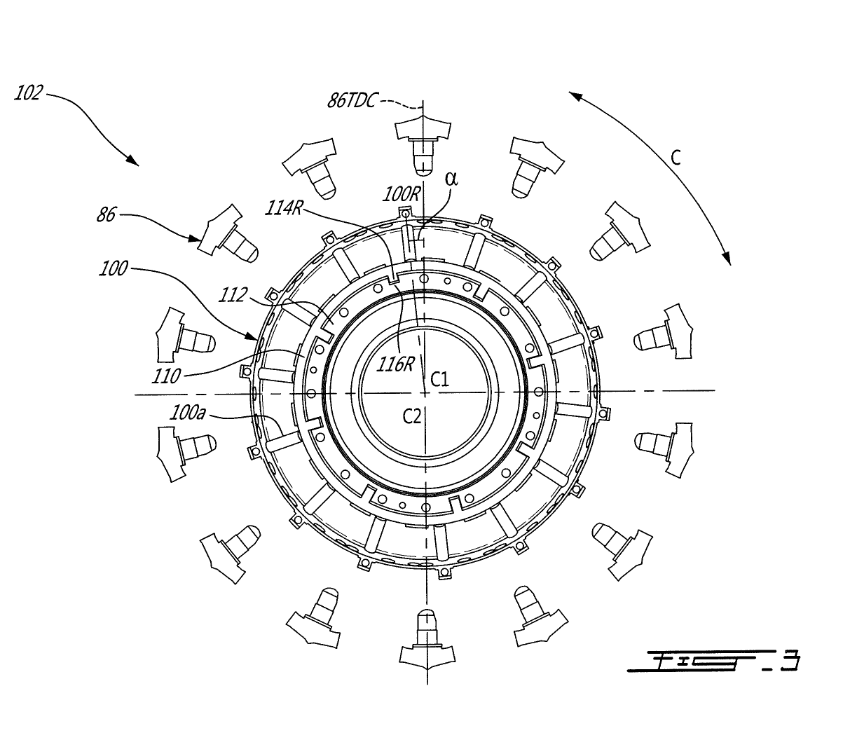

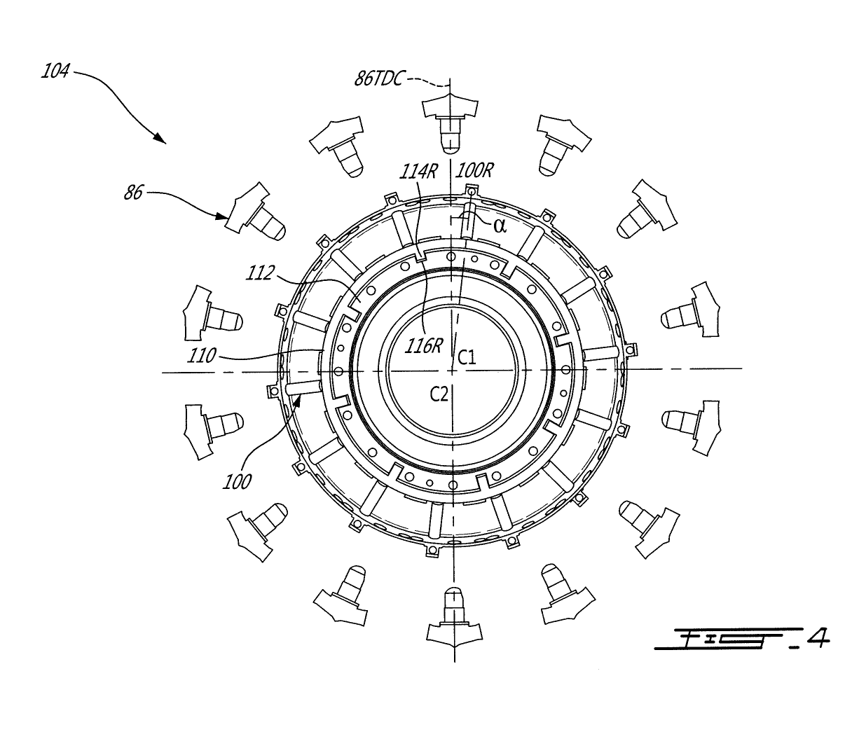

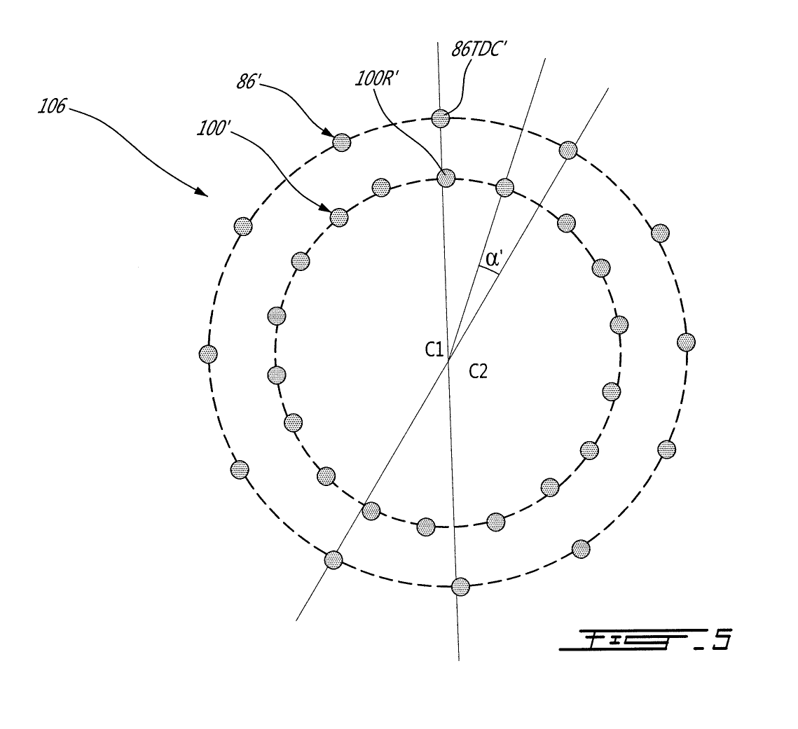

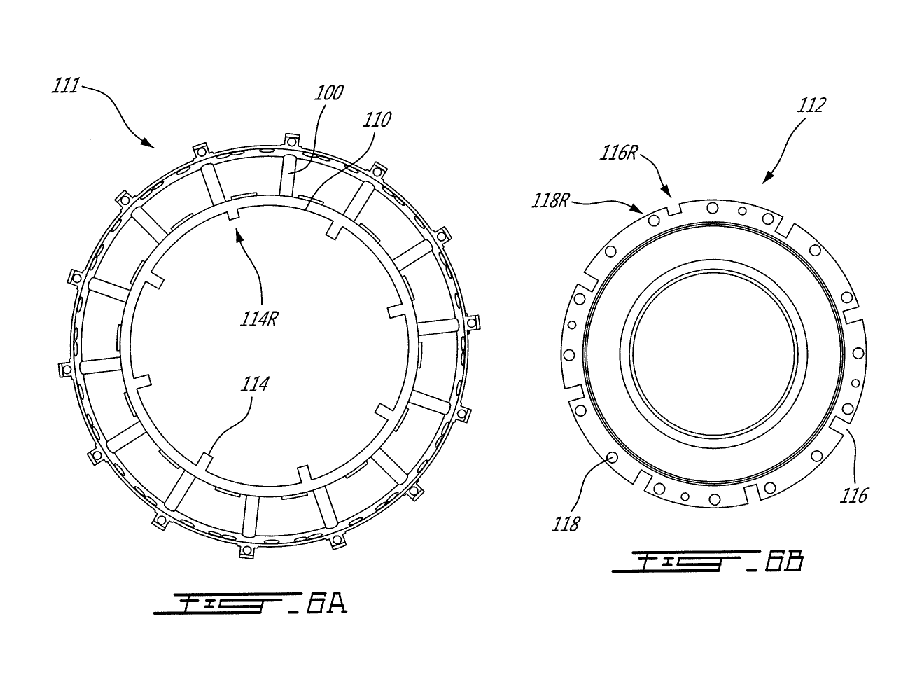

Referring now to FIGS. 3 and 4, a first arrangement 102 and a second arrangement 104 of the NGVs 100 relative to the fuel nozzles 86 will be described. The NGVs 100 are shown superimposed with the fuel nozzles 86 as seen from line A-A in FIG. 2. The NGVs 100 are disposed circumferentially equidistant from one another about a center C1. The fuel nozzles 86 are disposed circumferentially equidistant from one another about a center C2. The center C1 is superimposed or projected onto the center C2 (or vice versa) to provide the superimposition of FIGS. 3 and 4. To avoid cluttering the drawings, the fuel nozzles 86 are illustrated disposed outwardly relative to the NGVs 100, and elements of the gas turbine engine 10 between the NGVs 100 and the fuel nozzles 86 have been omitted. The superimposition of the NGVs 100 and the fuel nozzles 86 keeps the angular positions between the two as it is when seen from the line A-A in FIG. 2. The superimposition could also be done as seen from an opposite direction to the line A-A in FIG. 2. FIGS. 3 and 4 also show a vane ring 110 and inner cover 112, which will be described below in relation to FIGS. 6A and 6B.

In the first arrangement 102 and the second arrangement 104, the combustor 56 includes fourteen fuel nozzles 86. A reference position of the fuel nozzles 86 is indicated by the fuel nozzle 86TDC, which in this embodiment is disposed at the engine 10's Top Dead Center (TDC) position. This reference position is at angle zero. Another reference position could be used, and/or the NGVs 100 could be used as the reference position. The turbine section 28 includes fourteen NGVs 100 equidistantly disposed about a circumference.

The arrangements 102, 104 are said to be “clocked”, in that a closest NGV 100 to its adjacent (or circumferentially consecutive) fuel nozzle 86 is at a specific angle which allows the NGV 100 to lie in the flowpath of a pressure pulse. This can be seen, for example, with the fuel nozzle 86TDC position relative to its closest circumferentially consecutive vane, referred here as reference vane 100R, being at a clocking angle α. In one possible embodiment, the clocking angle α is a non-zero angle. Other NGVs 100 may be used to define the clocking angle α. In fact, an oriented clocking angle α can be defined between any NGV 100 and its closest fuel nozzle 86. When there is a same number of NGVs 100 and fuel nozzles 86, all the clocking angles have the same value. But when there is a different number of NGVs 100 and fuel nozzles 86, clocking angles of different values can be defined between the NGVs 100 and fuel nozzles 86. In the first arrangement 102 in FIG. 3, the clocking angle α is −6.17 degrees (counter clockwise) (−6 deg 10 min 0 sec). In the second arrangement 104 in FIG. 4, the clocking angle α is +6.69 degrees (clockwise) (+6 deg 41 min 26 sec).

The NGVs 100 may be curved from the leading edge 100a to the trailing edge 100b. The clocking angle α may thus be determined between an angular position of a fuel nozzle 86 and the angular position of the leading edge 100a of the circumferentially consecutive vane 100. It is however contemplated that the trailing edge 100b could instead be used.

When 14 NGVs 100 and associated fuel nozzles 86 are disposed equidistantly about a circumference, this leads to angular segments of 25.71 degrees, which leads to a clocking angle α comprised between −12.85 and +12.85 degrees.

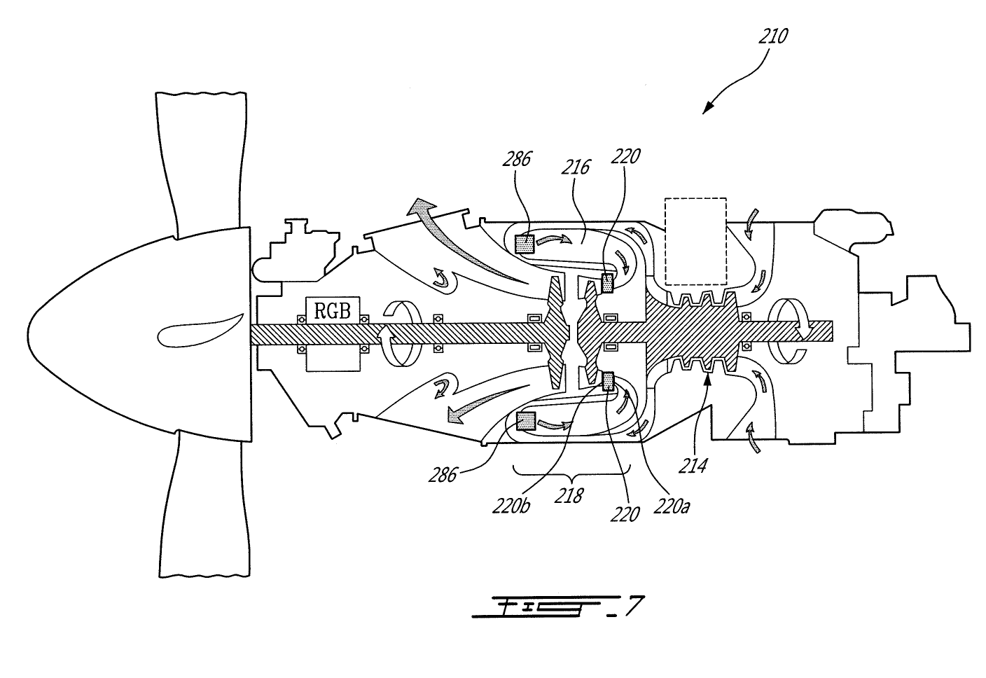

In any of the arrangements 102, 104, the clocking angle α may be determined in function of a spatial location of the pulses. The arrangement 104 may correspond to a gas turbine engine producing different pulses than that of the arrangement 102. For example, a compressor rotor and stator configuration of the gas turbine engine of the arrangement 104 may be shaped differently as a compressor rotor and stator configuration of the gas turbine engine of the arrangement 102, thereby producing a different pressure field in the combustor 56, and hence different pulses than the arrangement 102. In another example, the fuel nozzles 86 may be of different kinds between the arrangements 102, 104. Clocking between fuel nozzles and NGVs for a turboprop engine configuration comprising any arrangements of compressor rotors and stators, impeller, diffuser pipes and reverse flow combustor such as combustor 216 showed in FIG. 7 could also have specific clocking angles α. FIG. 7 shows an engine 210 having a compressor section 214 and a turbine section 218. The reverse flow combustor 216 includes a plurality of fuel nozzles 286 (only two being shown). The turbine section 218 includes NGVs 220 having a leading edge 220a and a trailing edge 220b.

The proposed arrangements could be made for a various number of circumferentially equidistantly disposed fuel nozzles 86 and/or NGVs 100 with or without equal number of fuel nozzles 86 and NGVs 100. Usually the number of fuel nozzles 86 (and associated NGVs 100) is between 10 and 30, which leads to clocking angles α being comprised between −18 and +18 degrees. There could be more fuel nozzles 86 than NGVs 100 or more NGVs 100 than fuel nozzles 86. For example, there could be one, two, four or more NGVs 100 than fuel nozzles 86. When there is an non equal number of fuel nozzles 86 and NGVs 100, a majority of the NGV 100 may be angularly offset from their circumferential consecutive fuel nozzle 86, and the clocking angles may have different values between the pairs of adjacent fuel nozzles 86/NGVs 100 (i.e. not all the clocking angles are equal). FIG. 6 shows an arrangement 106 with 12 circumferentially equidistantly spaced fuel nozzles 86′ and 18 circumferentially equidistantly spaced NGVs 100′. In this example, the top dead center fuel nozzle 86TDC′ is radially aligned with its closest NGV, the NGV 100R′. However there is at least one fuel nozzle 86 radially offset from with its closest NGV (see clocking angle α′).

Referring now to FIGS. 6A and 6B, the NGVs 100 are mounted on a vane ring 110 which is removably connected to an inner cover 112. The NGVs 100 and the vane ring 110 form together a stator 111. The inner ring 112 may be bolted to the engine casing using a plurality of bolts 118. The vane ring 110 may have a plurality of lugs 114 connectable to a plurality of matching slots 116 of the inner cover 112. The lugs 114 and slots 116 allow angular positioning of the stator 111, and thus the NGVs 100. The lugs 114 and slots 116 may be of lesser number than the NGVs 100, such as in FIGS. 3 and 4 (8 lugs 114 and slots 116 for 14 NGVs 10). It is however contemplated that the lugs 114 and slots 116 could be of a same or greater number than the NGVs 100. One of the lugs 114 and slots 116, reference lug 114R and corresponding slot 116R may be distinguishable, for example by being marked or shaped differently (as illustrated in FIGS. 3 and 4) to provide a reference when angularly positioning the stator relative to the fuel nozzle 86TDC. The reference lug 114R and associated slot 116R allow locating the reference vane 100R.

Because of the discrete number of lugs 114 and slots 116, there may be only a discrete number of angular positionings of the NGVs 100 relative to the fuel nozzles 86. In the example of FIGS. 3 and 4, there are 4 possible arrangements of the 14 NGVs 100 relative to the 14 fuel nozzles 86 using the 8 lugs 114 and slots 116 (rotating the ring 110 by one lug 114 in the counter clockwise direction results in a 45 degrees rotation of the vane ring 110—360 divided by 8—, successively rotating the vane ring 110 by 45 degrees three more times results in a 180 degrees total rotation, since the number of vanes 100 is even the rest of the eight possible lug rotations will be mirror images of the first 4 lug rotations). One of these possible arrangements may provide a better breakdown of the pressure pulses and therefore a reduction of the vibratory stresses of the blades located downstream of the vane relative to the other possible arrangements. The better possible arrangement using the predetermined number of lug and slots available on the stator may not be the best possible clocking of the NGVs 100 relative to the fuel nozzles 86, since the stator may not be constructed to allow every possible clocking angle. The angular positioning of the NGVs 100 relative to the fuel nozzles 86 may be done by trial and error or using computational methods. The lugs 114 and slots 116 may be designed to be able to provide an optimised clocking angle. It is contemplated that attachments others than the lugs 114 and slots 116 could be used. It is also contemplated that the lugs 114 could be on the inner cover 112 and the slots 116 on the vane ring 110.

The inner cover 112 itself may be clocked in a unique angular position so as to align the lugs 114 and slots 116 in a predetermined circumferential position. The inner cover includes a plurality of bolt holes 118 matching bolt holes (not shown) of the engine case (not shown). One of the bolt holes 118 is distinguishable from the other bolt holes 118. In this embodiment, an offset bolt hole 118R only lines up with one similarly offset bolt hole on the engine case. As a result, the inner cover 112 may only be positioned in a particular angular position. The combination of the offset bolt hole 118R and reference lug 114R and corresponding slot 116R may provide a unique NGVs 100 to fuel nozzles 86 clocking.

The proposed arrangement could also be applied to turbine vanes disposed downstream of the NGVs 100. Any vane stage of the turbine section 28 could be clocked relative to the fuel nozzles 86 in an effort to reduce vibration of the blade located downstream of the vane. As the flow travels through the various static and rotating stages, mixing takes place and pressure pulses originating from the fuel nozzles 86 may become less strong.

The above description is meant to be exemplary only, and one skilled in the art will recognize that changes may be made to the embodiments described without departing from the scope of the invention disclosed. Other modifications which fall within the scope of the present invention will be apparent to those skilled in the art, in light of a review of this disclosure, and such modifications are intended to fall within the appended claims.

1. A gas turbine engine comprising:
a combustor including:
a plurality of fuel nozzles arranged circumferentially equidistant from one another about a first center, the plurality of fuel nozzles producing a plurality of pressure pulses in a fluid contained in the combustor; and
a turbine section disposed downstream of the combustor and receiving the fluid from the combustor, the turbine section including:
a plurality of vanes arranged circumferentially equidistant from one another about a second center; and
wherein when projecting the second center onto the first center, the plurality of vanes being angularly offset in a circumferential direction relative to the plurality of fuel nozzles of a predetermined amount, the offsetting positioning the vanes in flowpaths of the pressure pulses generated by the plurality of fuel nozzles.

2. The gas turbine engine of claim 1, wherein the number of vanes is equal to the number of fuel nozzles.

3. The gas turbine engine of claim 2, wherein the number of vanes and fuel nozzles is 14.

4. The gas turbine engine of claim 1, wherein the number of vanes and the number of fuel nozzles is between 10 and 30.

5. The gas turbine engine of claim 1, wherein the number of vanes is different than the number of fuel nozzles.

6. The gas turbine engine of claim 1, further comprising a vane ring to which the plurality of vanes are attached, the vane ring including a plurality of attachments mating with corresponding plurality of attachments of an engine case of the gas turbine engine.

7. The gas turbine engine of claim 6, wherein the plurality of attachments of the vane ring are one of a plurality of lugs and mating slots, and the corresponding plurality of attachments in the engine case are the other one of the plurality of lugs and mating slots.

8. The gas turbine engine of claim 6, wherein one of the plurality of attachments is distinguishable from the other attachments and constitutes a reference attachment for angularly positioning the plurality of vanes.

9. The gas turbine engine of claim 6, wherein the attachments are arranged circumferentially equidistant from one another.

10. The gas turbine engine of claim 6, wherein a number of the attachments is smaller than a number of the vanes.

11. The gas turbine engine of claim 6, further comprising an inner cover disposed radially inwardly from the vane ring, the inner cover including the plurality of slots, the inner cover having a plurality of bolt holes for mounting the inner cover to the engine case, at least one of the bolt holes being distinguishable from the other bolt holes.

12. A gas turbine engine comprising:
a combustor including:
a plurality of fuel nozzles arranged circumferentially equidistant from one another about a first center, the plurality of fuel nozzles producing a plurality of pulses in a fluid contained in the combustor; and
a turbine section disposed downstream of the combustor and receiving the fluid from the combustor, the turbine section including:
a plurality of vanes arranged circumferentially equidistant from one another about a second center; and
wherein when projecting the second center onto the first center, the plurality of vanes being angularly offset in a circumferential direction relative to the plurality of fuel nozzles of a predetermined amount, the offsetting positioning the vanes in flowpaths of the pressure pulses generated by the plurality of fuel nozzles, a clocking angle being defined between any of the vanes and a circumferentially consecutive fuel nozzle of the vane, the clocking angle is comprised between −18 and +18 degrees.

13. The gas turbine engine of claim 12, wherein the clocking angle is comprised between −12.85 and +12.85 degrees.

14. The gas turbine engine of claim 12, wherein the number of vanes is equal to the number of fuel nozzles.

15. A method of reducing vibratory stresses in a turbine disposed downstream of a plurality of fuel nozzles of a gas turbine engine, the turbine including a rotor disposed immediately downstream from a stator, the method comprising:
positioning the vanes of the stator angularly offset in a circumferential direction relative to the fuel nozzles, the fuel nozzles forming pressure pulses of fluid and the angular offsetting disposing the vanes in flowpaths of the pressure pulses, the fuel nozzles being arranged circumferentially equidistant from one another about a first center, the vanes being arranged circumferentially equidistant from one another about a second center, the angular offsetting being assessed when projecting the second center onto the first center.

16. The method of claim 15, wherein angularly offsetting the vanes relative to the fuel nozzles includes angularly offsetting a vane ring of the stator relative to an inner cover by aligning a reference element of the vane ring with a reference element of the inner cover.

17. The method of claim 16, wherein the element of the vane ring is one of a lug and a slot and the element of the inner cover is a corresponding other one of the lug and slot.

18. The method of claim 15, wherein a number of vanes is equal to a number of fuel nozzles.

19. The method of claim 15, wherein angularly offsetting the vanes relative to the fuel nozzles includes forming a clocking angle comprised between −18 and +18 degrees, the clocking angle being defined between a vane and a circumferentially consecutive fuel nozzle when projecting the second center onto the first center.

20. The method of claim 19, wherein the clocking angle is comprised between −12.85 and +12.85 degrees.
